(19) United States
(12) Patent Application Publication
(10) Pub. No.: US 2015/0056394 A1
(43) Pub. Date: Feb. 26, 2015

(54) Coating Composition and Anti-Spatter Coating Formed Therefrom

(71) Applicant: ND Industries, Inc., Clawson, MI (US)

(72) Inventor: Norman M. Rawls, Sterling Heights, MI (US)

(21) Appl. No.: 14/464,063

(22) Filed: Aug. 20, 2014

Related U.S. Application Data
(60) Provisional application No. 61/868,545, filed on Aug. 21, 2013.

(51) Int. Cl. C09D 5/16

(52) U.S. Cl. CPC C09D 5/1618; C09D 5/1662
USPC 428/36.91; 428/447; 427/397.7; 427/387; 524/601; 524/261; 106/2

(57) ABSTRACT

A coating composition for forming an anti-spatter coating on a substrate is disclosed. The coating composition comprises a ceramic precursor, a curing agent, and optionally a cross-linkable resin. A coated article is also disclosed which comprises a substrate and the anti-spatter coating disposed on a surface of the substrate. The anti-spatter coating is the reaction product formed by curing the coating composition.

### FIELD OF THE INVENTION

The present invention generally relates to a coating composition and, more specifically, to a coating composition for forming an anti-spatter coating on a substrate.

### DESCRIPTION OF THE RELATED ART

Welding is a fabrication process that joins materials, usually metals or thermoplastics, by causing melting and coalescence. One of the various welding processes is arc welding, which uses a welding power supply to create and maintain an electric arc between an electrode and the base material to melt metal at the welding point. Common types of arc welding include shielded metal arc welding, also known as stick welding, which strikes an arc between the base material and consumable steel electrode rod that is covered with a CO₂ flux that protects the welding area from oxidation and contamination; tungsten inert gas (TIG) welding, which uses a nonconsumable electrode made of tungsten, an inert or semi-inert gas mixture, and a separate filler material; and metal inert gas (MIG) welding, also known as gas metal arc welding, which is a semi-automatic or automatic welding process that uses a continuous feed of welding wire as an electrode and an inert or semi-inert gas mixture to protect the weld from contamination.

One of the disadvantages associated with welding of metal is that the process generates substantial weld spatter, which is made up of elements found in both the workpiece that is being welded and the welding electrode or wire. These elements include iron, aluminum, and silicon. Weld spatter is metal that is spattered by extreme heat of the arc, which causes the molten metal to boil so that droplets of molten or liquid metal are sprayed from the arc. When a nozzle is used, such as in MIG or TIG welding processes, the liquid or molten metal over time builds up on the nozzle and tip during continuous use, and longer welding times result in a larger buildup of weld spatter deposits. In addition to high welding temperatures, factors such as improper amperage setting, wire feed rate, and the type of the substrate being welded cause weld spatter.

Weld spatter adheres to the workpiece and various parts of the welding gun, including the tip and nozzle, thus affecting the quality of the weld by obstructing the nozzle and the longevity and performance of the welding gun by causing rapid deterioration of the tip and nozzle. This is especially true in MIG welding, in which the electrode wire and gas are supplied directly through the tip and the nozzle of the welding gun.

When welding, the buildup of weld spatter on consumables causes several problems. Weld spatter build up can disrupt gas flow which leads to poor quality welds. Additionally, buildup of spatter on a weld tip can lead to the tip welding itself shut, often requiring the tip to be replaced. In automated welding, this would require the whole cell to be shut down for replacement, which leads to a decrease in efficiency.

The traditional cleaning method used in automated welding is reaming the weld tip and nozzle with a blade. This process, however, is often quite damaging to the nozzles. Additionally, the cleaning is only temporary and may have to be repeated every few parts to keep the parts free of significant spatter build-up. The constant upkeep needed with reaming significantly decreases the efficiency of the welding cell.

When using a traditional welding tip and nozzle assembly, weld spatter must be removed from the welding gun at frequent intervals to ensure proper weld formation. Depending on the welding process and the type of material and equipment used, the traditional welding tip and nozzle assembly requires removal of weld spatter as frequently as after about three welding operations, i.e., after forming about three welds. Removal of spatter, however, slows the welding process and reduces the efficiency of the process, as it requires grasping and separating the spatter from the nozzle with pliers or reaming the nozzle. Furthermore, reaming or scoring used in robotic operations is a highly abrasive process that can scratch or damage the nozzle, and damage from reaming compromises the performance of the nozzle.

### SUMMARY OF THE INVENTION

The present invention provides a coating composition for forming an anti-spatter coating on a substrate. The coating composition comprises a ceramic precursor, a curing agent, and optionally a cross-linkable resin.

The present invention also provides a coated article. The coated article comprises a substrate. The coated article further comprises an anti-spatter coating disposed on a surface of the substrate. The anti-spatter coating comprises the reaction product formed by curing a coating composition, which comprises a ceramic precursor, a curing agent, and optionally a cross-linkable resin.

Finally, the present invention provides a method of preparing an anti-spatter coating on a welding device. The method comprises applying on the welding device the coating composition curing the coating composition on the welding device to give the anti-spatter coating.

### DETAILED DESCRIPTION OF THE INVENTION

The present invention provides a coating composition for forming an anti-spatter coating on a substrate. The coating composition and resulting anti-spatter coating are particularly suited for applications involving high temperatures, e.g. in welding applications. For example, the coating composition may be utilized to form anti-spatter coatings on welding devices. However, the coating composition is not limited to such welding applications. For example, the coating composition may be utilized in other coating applications, such as in coil coatings or in paint masking.

The coating composition comprises a ceramic precursor. The ceramic precursor is generally not a ceramic while present in the coating composition. Instead, the ceramic precursor may be utilized to form a ceramic in the anti-spatter coating formed by curing the coating composition. For example, upon applying an appropriate curing condition to the coating composition, the coating composition cures, and the ceramic precursor forms a ceramic in the anti-spatter coating. The ceramic formed by the ceramic precursor may be crystalline, partially-crystalline, or amorphous. Further, the ceramic formed by the ceramic precursor may be continuous throughout the anti-spatter coating, or localized or segmented therein dependent upon the relative amounts of components in the coating composition.

The ceramic precursor is not limited and may be selected from any suitable component or polymer that may be utilized to form the ceramic. Typically, the ceramic precursor is selected such that the coating composition is flowable or pourable at room temperature. Without being bound by theory, it is believed that the ceramic precursor provides, among other benefits, elevated heat resistance and tolerance to the anti-spatter coating formed from the coating composition. It is also believed that the ceramic precursor can impart abrasion resistance characteristics and may significantly reduce thermal adhesion of the anti-spatter coating and facilitates removal of any adhered material, i.e., any spatter, from the anti-spatter coating. It is further believed that the ceramic precursor, in combination with the other components of the coating composition disclosed herein, reduces or substantially prevents any spatter from coalescing or melding with the anti-spatter coating. It is also believed that the ceramic precursor can provide protection to the anti-spatter coating and underlying substrate by preventing or reducing thermal damage and/or thermal adhesion caused by high temperatures in the environment in which the anti-spatter coating is utilized or exposed. Thermal damage includes burning, melting, metal discoloration, metal distortion, and other deleterious effects of the anti-spatter coating or the substrate caused by heat. The term “thermal adhesion,” as used herein, includes adhesion of material caused by heat, for example by being sprayed or otherwise deposited onto a substrate which is capable of adhering to the surface, e.g. molten or liquid form. An example of thermal adhesion is weld spatter adhesion.

The ceramic precursor may be monomeric, oligomeric, polymeric, or comprise a combination or blend of different types thereof. For example, in various embodiments, the ceramic precursor is hydrolysable. Thus, when the ceramic precursor is monomeric and hydrolysable, the ceramic precursor may be partially hydrolysed and condensed to form an oligomeric or polymeric ceramic precursor.

Specific examples of ceramic precursors that are monomeric include orthosilicates, halosilanes, metal alkoxides, and combinations thereof.

In certain embodiments, the ceramic precursor comprises an orthosilicate. Orthosilicates are generally known in the art and typically include an SiO₄⁴⁻ ion, which may be bonded via an ionic bond and/or a covalent bond to another ion, moiety, or substituent. Generally, when the ceramic precursor comprises an orthosilicate, the orthosilicate is a tetrahedral molecule. Specific examples of orthosilicates suitable as the ceramic precursor include those having the general formula Si(OR)₄, where each R is an independently selected alkyl group having from 1 to 4 carbon atoms. In this instance, the ceramic precursor may alternatively be referred to as an alkoxysilane or a tetraalkoxy silane. Specific examples of such orthosilicates include tetramethyl orthosilicate, tetraethyl orthosilicate, tetrapropyl orthosilicate, tetrabutyl orthosilicate, dimethyldiethyl orthosilicate, methyltriethyl orthosilicate, etc. Alternatively, when the ceramic precursor comprises the orthosilicate, the orthosilicate need not include four silicon-bonded alkoxy groups. For example, the ceramic precursor may have the general formula RSi(OR)₃, where R is defined above. Specific examples thereof include methyltriethoxysilane, ethyltriethyloxysilane, methyltrimethoxysilane, etc. Orthosilicates are commercially available or may be prepared by, for example, alocholysis of halosilanes.

In certain embodiments, the ceramic precursor comprises a halosilane. Halosilanes are generally known in the art and typically comprise a central silicon atom having silicon-bonded halogen atoms. The silicon-bonded halogen atoms may independently be selected from F, Cl, Br, and I. In certain embodiments, the halosilane consists of silicon and halogen atoms, in which case the halosilane has the general formula SiX₄, where each X is an independently selected halogen atom. However, the halosilane may have the general formula R¹ₐSiX₄₋ₐ, where each R¹ is an independently selected hydrocarbyl group, each X is an independently selected halogen atom, and subscript a is a 0, 1 or 2. Typically, subscript a is 0 or 1, most typically 0. Specific examples of suitable halosilanes include tetrachlorosilane, methyltrichlorosilane, tetrafluorosilane, etc. Halosilanes are commercially available and may be prepared by, for example, reacting silicon with a halogen, e.g. chlorine.

In certain embodiments, the ceramic precursor comprises a metal alkoxide. Metal alkoxides are generally known in the art and typically and include a metal atom and at least one alkoxide bonded thereto. For example, metal alkoxides may have the general formula M(OR¹)ₙ, where M is a metal atom, each R¹ is an independently selected hydrocarbyl group, and subscript n is an integer from 1 to a maximum valence of M. Each R¹ is typically an alkyl group, e.g. a C₁₋₁₂ alkyl group, a C₁₋₆ alkyl group, or a C₁₋₄ alkyl group. When R¹ has three or more atoms, R¹ may independently be branched or linear. The metal atom represented by M is not limited and may be, for example, a Group I element, a Group II element, a transition metal, a metalloid, a post transition metal, etc. Specific examples of suitable metal alkoxides include titanium isopropoxide, titanium ethoxide, zirconium ethoxide, aluminum isopropoxide, zinc isopropoxide, etc.

Combinations of different monomeric ceramic precursors may be utilized in concert with one another in the coating composition.

As introduced above, the ceramic precursor may alternatively be oligomeric or polymeric. In these embodiments, the ceramic precursor may comprise any partial hydrolysis/condensation product of any of the monomeric ceramic precursors identified above, so long as the resulting hydrolysis/condensation product is capable of further hydrolysis and/or condensation, i.e., so there are residual functionalities in the hydrolysis/condensation product.

Specific examples of ceramic precursors that are polymeric and/or oligomeric include polyalkylalkenylsilane, a polytitanocarbosilane, a polysilaalkylene, a polyalkenylarylsilazane, a polyborosilazane, a polyboronsiliconimide, a polyhydrocarbylsilsesquioxane, and combinations thereof. Generally, the distinction between polymers and oligomers is based on molecular weight or chain length, as understood in the art.

The organic substituents of the ceramic precursors that are polymeric and/or oligomeric generally have from 1-12 carbon atoms. For example, the alkyl, alkenyl, alkylene, aryl, and hydrocarbyl groups typically have from 1-12 carbon atoms. Alkyl groups are acyclic, branched or unbranched, saturated monovalent hydrocarbon groups exemplified by methyl, ethyl, propyl, butyl, penyl, hexyl, heptyl, octyl, etc. Alkenyl groups are acyclic, branched or unbranched, monovalent hydrocarbon group having one or more carbon-carbon double bonds. Alkenyl groups are exemplified by vinyl, allyl, propenyl, and hexenyl. Alkylene groups are acyclic, branched or unbranched, saturated divalent hydrocarbon group. Aryl groups are cyclic, fully unsaturated, hydrocarbon groups exemplified by cyclopentadienyl, phenyl, anthracenyl, and naphthyl. Hydrocarbyl groups are monovalent hydrocarbon groups and may independently be, for example, alkyl groups, alkenyl groups, aryl groups, etc. Such substituents in the ceramic precursors may be independently selected.

Specific examples of species of ceramic precursors that are polymeric and/or oligomeric include polymethylvinylsilane, polytitanocarbosilane, polysilaethylene, polyvinylphenylsilazane, polyborosilazane, polyboronsiliconimide, polyphenylsilsesquioxane, and combinations thereof. One of skill in the art understands that the substituents of these specific examples may be replaced with others, e.g. methyl can be replaced with ethyl, vinyl can be replaced with allyl, etc. All different variations are expressly contemplated herein.

Combinations of different polymeric and/or oligomeric ceramic precursors may be utilized, and polymeric and/or oligomeric ceramic precursors may be utilized in combination with one or more monomeric ceramic precursors.

The ceramic precursor may be utilized in the coating composition in various amounts, which is generally a factor of the desired properties of the anti-spatter coating and the presence or absence of various optional components. In various embodiments, the ceramic precursor is present in an amount of from 10 to less than 100 weight percent based on the total weight of the coating composition. For example, the ceramic precursor may constitute a major component of the coating composition, such as when the ceramic precursor is present in an amount of from 10 to less than 100, alternatively from 50 to less than 100, alternatively from 75 to less than 100, weight percent based on the total weight of the coating composition. In other embodiments, the ceramic precursor is present in the coating composition in an amount of from 10 to 50, alternatively from 15 to 30, weight percent based on the total weight of the coating composition.

The coating composition optionally comprises a cross-linkable resin. The cross-linkable resin is typically present in the coating composition and is typically organic. In certain embodiments, the cross-linkable resin comprises a polyester resin, typically modified with at least one fatty acid. For example, cross-linkable resins may be derived from polyols and an acid or acid anhydride, such as carboxylic acid or carboxylic acid anhydride. Alternatively, the cross-linkable resin may comprise a hydroxyl functional siliconized organic resin.

In various embodiments, the cross-linkable resin comprises a hydrolysable resin, such as an alkyd resin. Alkyd resins may alternatively be referred to as alkyd polymers, particularly when linear. In other embodiments, the cross-linkable resin comprises a phenolic resin, an acrylic resin, a phenoxy resin, or a melamine resin.

When utilized, the cross-linkable resin may be present in the coating composition in various amounts, which is generally a factor of the desired properties of the anti-spatter coating and the presence or absence of various optional components. In various embodiments, when utilized, the cross-linkable resin is present in an amount of from greater than 0 to less than 50, alternatively from greater than 0 to less than 25, weight percent based on the total weight of the coating composition. In other embodiments, the cross-linkable resin is present in the coating composition in an amount of from 5 to 20 weight percent based on the total weight of the coating composition.

The coating composition further comprises a curing agent. The curing agent is typically selected so as to be compatible with the cross-linkable resin, if utilized in the coating composition. The curing agent may alternatively be referred to as a crosslinking agent. The curing agent typically comprises an acid, e.g. arylsulfonic acid.

In certain embodiments including the cross-linkable resin where the cross-linkable resin comprises the alkyd resin, the curing agent may comprise a prepolymer that is reactive with the alkyd resin.

The curing agent may be utilized in the coating composition in various amounts, which is generally a factor of the desired properties of the anti-spatter coating and the presence or absence of various optional components. In various embodiments, the curing agent is present in an effective amount for curing the coating composition, which is readily determinable by one of skill in the art. In certain embodiments, the curing agent is present in an amount of from greater than 0 to less than 25, alternatively from greater than 0 to 10, alternatively from 0.25 to 5.0, weight percent based on the total weight of the coating composition.

In various embodiments, the coating composition further comprises a release agent. The release agent may comprise, for example, aluminum tri-hydroxide, graphite, boron nitride, aluminosilicate, calcium carbonate, and combinations thereof.

In certain embodiments, the release agent comprises graphite, optionally in combination with at least one organic compound. The inorganic compound may be boron nitride. Alternatively, the inorganic compound may comprise a Group VI element, such as chromium, molybdenum, tungsten, etc. One example of an inorganic compound comprising a Group VI element is molybdenum disulfide. In various embodiments, the release agent comprises a combination of graphite and molybdenum disulfide. In other embodiments, the release agent comprises a combination of graphite and boron nitride.

The release agent, when utilized, may be present in the coating composition in various amounts, which is generally a factor of the desired properties of the anti-spatter coating and the presence or absence of various optional components. In various embodiments, the release agent is present in an amount of from greater than 0 to 80, alternatively from 5 to 60, alternatively from 10 to 40, weight percent based on the total weight of the coating composition.

The coating composition may optionally comprise other fillers, such as extending and/or reinforcing fillers, which may also serve in combination with the release agent for improving properties of the anti-spatter coating. Fibrous materials or fibers are also within the scope of such fillers. Fillers may have a variety of particle sizes, e.g. from dust-like particles to coarse-grain particles to elongated fibers. The filler may be organic and/or inorganic. Specific examples of fillers suitable for the coating composition in particle form include clays, such as kaolin; chalk; wollastonite; talcum powder; calcium carbonate; silicates; silica; ferrites; titanium dioxide; zinc oxide; glass particles, e.g. glass beads; and nanoscale fillers, such as carbon nanotubes, carbon black, nanoscale and other phyllosilicates, nanoscale aluminum oxide (Al₂O₃), nanoscale titanium dioxide (TiO₂), graphene, and nanoscale silicon dioxide (SiO₂). Nanoscale fillers typically have at least one dimension of less than 100 nanometers (nm). Specific examples of fillers suitable for the adhesive composition in fibrous form include boron fibers; glass fibers; carbon fibers; silica fibers; ceramic fibers; basalt fibers; aramid fibers; polyester fibers; nylon fibers; and polyethylene fibers. If utilized, the fillers are typically inorganic so as not to burn at high temperatures, e.g. in the environment in which the anti-spatter coating is employed.

The coating composition can additionally include one or more additives, including a catalyst for accelerating the curing process; a surfactant; a thickener, e.g. polyethylene oxide; a suspension agent, e.g. alginic acid salt; a dispersing agent; an anti-stick agent; wax, e.g. polyethylene wax; a freeze preventing agent, e.g. ethylene glycol, propylene glycol, glycerin, MP-Diol; an anti-skinning agent, e.g. ethylene glycol, propylene glycol, glycerin, MP-Diol; and a pigment. If utilized, such additives are typically present in an amount effective to provide the desired characteristic to the anti-spatter coating, typically from 0.1 to 10 percent by weight based on the total weight of the coating composition.

In certain embodiments, the coating composition further comprises a carrier vehicle for dispersing the components of the coating composition. The carrier vehicle may alternatively be referred to as a solvent when the carrier vehicle solubilizes the components of the coating composition. Suitable carrier vehicles include organic carriers, which may be polar or nonpolar. For example, the carrier vehicle may comprise a substituted or unsubstituted hydrocarbon solvent, which may be aromatic. Alternatively, the carrier vehicle may comprise a substituted or unsubstituted alcohol. Alternatively still, the carrier vehicle may comprise water, optionally in combination with such a polar or nonpolar organic solvent. Non-limiting examples include xylene and xylene isomers and derivatives, benzene and benzene derivatives, methyl ethyl ketone (MEK), acetone, and alcohols having between 1 and 10 carbon atoms, e.g. isopropanol, n-propanol and the like. Combinations of different carrier vehicles may be utilized in concert with one another.

When utilized, the carrier vehicle is typically present in the vehicle in a sufficient amount to permit the wet application of the coating composition. The carrier vehicle is typically driven from the coating composition, e.g. by heat and/or evaporation, as it cures to form the anti-spatter coating. This amount is readily identifiable by one of skill in the art based on the components of the coating composition. In various embodiments, the coating composition comprises the carrier vehicle in an amount of from 10 to 70 weight percent based on the total weight of the coating composition.

A coated article is also disclosed. The coated article comprises a substrate and the anti-spatter coating disposed on a surface of the substrate. The anti-spatter coating is formed by curing the composition.

The substrate may be any substrate for which an anti-spatter coating is desirable. For example, the substrate may comprise a metal or alloy, glass, ceramic, a polymeric material, etc. In specific embodiments, the substrate comprises a welding device. Generally, any portion of the welding device for which an anti-spatter coating is desirable may be coated with the coating composition. Typically, at least a nozzle or tip of the welding device is coated with the coating composition and ultimately the anti-spatter coating. Nozzles and tips of welding devices typically comprise a metal or alloy such as copper, nickel, and/or brass. Specific examples of suitable welding devices, nozzles and tips are disclosed in U.S. Publ. Pat. Appln. No. 2007/0090168, which is incorporated by reference herein in its entirety.

The coating composition may be applied on the surface of the substrate by any suitable coating method, including such as dip coating, spin coating, flow coating, spray coating, roll coating, gravure coating, sputtering, slot coating, inkjet printing, and combinations thereof.

In certain embodiments when the substrate comprises the welding device, the tip and/or the nozzle can be dipped into the coating composition, or the coating composition may be sprayed or brushed on the surface of the tip and/or the exterior and interior surfaces of the nozzle. The coating composition can be applied to the surface of the substrate in one application or in multiple sequential applications to achieve a desired thickness of the anti-spatter coating. When more than one layer of the coating composition is applied, the layers may be individually cured, partially cured, or dried prior to applying the sequential layer. For example, the coating composition may be applied to the surface of the substrate to form an initial layer, and the initial layer may be cured, partially cured, or dried, e.g. by application of heat, to drive any carrier vehicle from the initial layer and/or to cure or partially cure the components thereof. Subsequent layers may be applied to achieve a desired thickness of the resulting anti-spatter coating by repeating these steps. Drying is distinguished from curing, as drying merely drives the carrier vehicle from the coating composition without initiating curing or crosslinking of the components thereof.

The thickness and amount of the coating composition applied may be adjusted depending on the size and configuration of the substrate and its intended use.

The coating composition, or the layer formed by applying the coating composition on the surface of the substrate, is cured to form the anti-spatter coating on the substrate and give the coated article. Curing is typically carried out via the application of heat, e.g. by baking the substrate including the coating composition disposed thereon in an oven. Curing conditions may vary based on a selection of the components of the coating composition, as understood in the art. In certain embodiments, curing the coating composition is carried out at a temperature of from 100 to 250° C. for a period of time from 5 to 120 minutes. Curing may be carried out sequentially at increased temperatures to first drive the carrier vehicle from the coating composition and then to form a high molecular weight and/or cross-linked host matrix formed from the cross-linkable resin, if present. Optionally, after curing the coating composition, a post-baking step may be carried out at a temperature from 300 to 1000° C. for a period of time from 0.25 to 4 hours. When utilized, the post-baking step is employed to promote ceramic conversion of the ceramic precursor.

The anti-spatter coating according to the invention provides superior protection against adhesion and accumulation of weld spatter, including those containing mild steel or galvanized steel commonly used as work pieces in MIG welding, as well as other thermal adhesion.

When using traditional uncoated MIG nozzle assemblies, the welding process must be frequently interrupted to disconnect the traditional nozzle assembly to remove the spatter, which typically requires filing, and the nozzle is typically periodically reamed, which can be as little as after about three welds. Surprisingly, over at least 50, alternatively at least 100, alternatively at least 150, alternatively at least 200, welding operations can be performed continuously without interrupting the operation to remove weld spatter from the nozzle including the anti-spatter coating, after which accumulated weld spatter can be dislodged and removed simply by light impact.

The anti-spatter coating therefore allows the welding tip and nozzle assembly to maintain an acceptable level of gas flow to the weld through multiples runs of welding operations, and reduces the likelihood of producing a defective weld. By inhibiting spatter adhesion, the anti-spatter coating also reduces incidents of burn back, thereby reducing the likelihood of premature tip replacement.

As introduced above, however, the anti-spatter coating is not specifically limited to welding devices. For example, it is contemplated that the coating composition disclosed herein can be employed in other temperature sensitive applications, such as circuit-based applications and the like.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The following examples are intended to illustrate the invention and are not to be viewed in any way as limiting to the scope of the invention.

### EXAMPLES

### Example I

A solution is prepared by combining 9.1 grams of alkyd resin, 9.1 grams of xylene, 4.6 grams of melamine resin, 18.7 grams of tetraethyl orthosilicate, 18.2 grams of titanium dioxide, 22.6 grams of boron nitride, 5 grams of graphite, 2.7 grams of modified kaolin clay, and 3.0 grams of isopropyl alcohol. The components are admixed until the components are dissolved and/or dispersed in the solution. 6.4 grams of isopropyl alcohol, 0.4 grams of deionized water, and 0.4 grams of an arylsulfonic acid solution in isopropyl alcohol and n-propanol are added to the solution to form a coating composition, which is a flowable liquid.

The coating composition is applied on a surface of two substrates. The substrates comprise steel panels having dimensions of 1×4×0.06 inches. The substrates are dipped into a pool of the coating composition. The coated panels are cured at 70° C. for 10 minutes, followed by a cure interval of 125° C. for 10 minutes, which was further followed by a cure interval of 200° C. for 5 minutes. After completion of the final curing interval, the resulting panels are placed in a 371° C. (700° F.) furnace for one hour to form anti-spatter coatings on the substrates.

In order to ascertain adhesion of the anti-spatter coatings to the substrates, the first panel is removed from the furnace and immediately dropped into a room temperature water bath. The panel and the anti-spatter coating are inspected visually. The anti-spatter coating remained adhered to the panel, indicating that the anti-spatter coating would remain adhered through instances of the thermal shock (in view of the significant temperature difference between 371° C. and room temperature and thermal expansion of the substrate). The second panel is removed from the furnace and immediately brushed with steel bristle brush while hot. The panel and the anti-spatter coating are visually inspected during and after brushing the anti-spatter coating. The anti-spatter coating remained adhered to the substrate through light and moderate brushing, illustrating excellent physical properties of the anti-spatter coating.

### Example II

The coating composition of Example I is applied to a weld tip and nozzle and cured sequentially using the process outlined in the Example I to form anti-spatter coatings on the weld tip and nozzle. The weld tip and nozzle including the anti-spatter coating are installed in a Miller Deltaweld® 300 welding device, commercially available from Miller Electric Mfg. Co. of Appleton, Wis. Test welds are carried out with the welding device including the antis-spatter coating on the weld tip and nozzle. The anti-spatter coating was still adhered to the weld tip and nozzle after 100 consecutive welds each for a distance of 1 foot.

### Example III

A polymeric ceramic precursor is prepared via the sol-gel method. In particular, 50 grams of triethoxymethylsilane (TEMS), 0.6 grams of a 30% citric acid solution, 13.5 grams of deionized water, and 20.6 grams acetone are blended together. 1 gram of polyethylene oxide resin is added as a thickening agent to form a mixture. The mixture is sealed in a vessel and placed in an oven overnight at 48° C.

The next day, a coating composition is prepared by combining 30 grams of the mixture formed above including the polymeric ceramic precursor, 4 grams of graphite, 3 grams of boron nitride, 3 grams of titanium dioxide, 1 gram of a modified kaolin clay, and 0.5 grams of an arylsulfonic acid solution. All of the components are dispersed in the coating composition. The coating composition is applied to substrates, i.e., aluminum test panels.

The coating compositions are dried on the aluminum test panels at 100° C. for 15 minutes and then the aluminum test panels including the dried coating compositions are placed in a 200° C. oven for 10 minutes to cure the dried coating compositions and form anti-spatter coatings. The resulting anti-spatter coatings are subjected to 482° C. (900° F.) for two hours and did not delaminate from the aluminum test panels. To demonstrate heat shock resistance of the anti-spatter coating, one aluminum test panel including the anti-spatter coating is heated to 400° C. and immediately quenched in deionized water. The anti-spatter coating remained adhered to the aluminum test panel without delamination.

The invention has been described in an illustrative manner, and it is to be understood that the terminology which has been used is intended to be in the nature of words of description rather than of limitation. Many modifications and variations of the present invention are possible in light of the above teachings. The invention may be practiced otherwise than as specifically described.

What is claimed is:

1. A coating composition for forming an anti-spatter coating on a substrate, said composition comprising:
a ceramic precursor;
a curing agent; and
optionally a cross-linkable resin.

2. The coating composition of claim 1 wherein said ceramic precursor comprises a monomeric ceramic precursor selected from an orthosilicate, a halosilane, a metal alkoxide, and combinations thereof.

3. The coating composition of claim 1 wherein said ceramic precursor comprises a polymeric ceramic precursor selected from a polyalkylalkenylsilane, a polytitanocarbosilane, a polysilaalkylene, a polyalkenylarylsilazane, a polyborosilazane, a polyboronsiliconimide, a polyhydrocarbylsilsesquioxane, and combinations thereof.

4. The coating composition of claim 1 further comprising a release agent which comprises graphite and at least one inorganic compound.

5. The coating composition of claim 1 wherein the cross-linkable resin is present and comprises an organic alkyd resin.

6. A coated article, comprising:
a substrate; and
an anti-spatter coating disposed on a surface of the substrate, said anti-spatter coating comprising the reaction product formed by curing a coating composition, which comprises:
a ceramic precursor;
a curing agent; and
optionally a cross-linkable resin.

7. The coated article of claim 6 wherein said ceramic precursor of said coating composition comprises a monomeric ceramic precursor selected from an orthosilicate, a halosilane, a metal alkoxide, and combinations thereof

8. The coated article of claim 6 wherein said ceramic precursor of said coating composition comprises a polymeric ceramic precursor selected from a polyalkylalkenylsilane, a polytitanocarbosilane, a polysilaalkylene, a polyalkenylarylsilazane, a polyborosilazane, a polyboronsiliconimide, a polyhydrocarbylsilsesquioxane, and combinations thereof.

9. The coated article of claim 6 wherein said coating composition further comprises a release agent comprising graphite and at least one inorganic compound.

10. The coated article of claim 9 wherein said inorganic compound comprises boron nitride, a Group six element, or combinations thereof.

11. The coated article of claim 10 wherein said inorganic compound comprises said Group six element and wherein said Group six element comprises molybdenum.

12. The coated article of claim 10 wherein said inorganic compound comprises molybdenum disulfide.

13. The coated article of claim 6 wherein said cross-linkable resin is present in said coating composition and comprises an organic alkyd resin.

14. The coated article of claim 6 wherein said curing agent comprises melamine.

15. The coated article of claim 6 wherein said substrate comprises a welding device.

16. The coated article of claim 6 wherein said substrate comprises a nozzle of a welding device.

17. The coating article of claim 6 wherein said coating composition further comprises a carrier vehicle.

18. A method of preparing an anti-spatter coating on a welding device, said method comprising applying on the welding device a coating composition in accordance with claim 1 and curing the coating composition on the welding device to give the anti-spatter coating.
